(19) United States
(12) Patent Application Publication
(10) Pub. No.: US 2025/0049054 A1
(43) Pub. Date: Feb. 13, 2025

(54) SYSTEMS AND METHOD FOR REFRIGERATED SMOKING

(71) Applicant: Steve DeLorean, Philadelphia, PA (US)

(72) Inventor: Steve DeLorean, Philadelphia, PA (US)

(21) Appl. No.: 18/783,836

(22) Filed: Jul. 25, 2024

Related U.S. Application Data
(60) Provisional application No. 63/532,193, filed on Aug. 11, 2023.

(51) Int. Cl. A23B 4/052; F25D 17/04; F25D 17/06; F25D 31/00

(52) U.S. Cl. CPC A23B 4/052; F25D 17/045; F25D 17/062; F25D 31/005

(57) ABSTRACT

A system and method for refrigerated smoking items is described herein. For example, a refrigerated smoker may contain a smoke generator configured to generate smoke at a first temperature. In some examples, a first end of the smoke generator may be coupled to a first end of a heat exchanger configured to receive the smoke from the smoke generator. In some examples, the refrigerated smoker may further comprise a refrigerated smoking chamber coupled to a second end of the heat exchanger, such that the refrigerated smoking chamber may receive, from the heat exchanger, the smoke at the second temperature. The refrigerated smoking chamber may be capable of receiving one or more products, such as food items, such that when products are placed in the refrigerated smoking chamber, they may be exposed to the smoke at the second temperature.

### RELATED APPLICATIONS

This application claims the benefit of, and priority to, U.S. Provisional Patent Application No. 63/532,193, filed on Aug. 11, 2023, the entire contents of which are incorporated herein by reference.

### BACKGROUND

Natural wood smoke carries a distinct and noteworthy flavor which may be incorporated into a variety of food products. Difficulty arises, however, when the average at home chef desires such smokey flavor. The addition of a smokey flavor is typically accomplished by exposing food to smoke for a long period of time or by cooking with a smoke flavored liquid. Such methods often require hours of labor, and still end in unsatisfactory results. As such, existing techniques for imparting smoke flavor are limited.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features. Furthermore, the drawings may be considered as providing an approximate depiction of the relative sizes of the individual components within individual figures. However, the drawings are not to scale, and the relative sizes of the individual components, both within individual figures and between the different figures, may vary from what is depicted. In particular, some of the figures may depict components as a certain size or shape, while other figures may depict the same components on a larger scale or differently shaped for the sake of clarity.

FIG. 1 illustrates a perspective view of an example refrigerated smoking system, as described herein.

FIG. 2 illustrates a perspective view of an example refrigerated smoking chamber system, as described herein.

FIG. 3 illustrates a perspective view for distributing smoke within a refrigerated smoking chamber, as described herein.

FIG. 4 illustrates a perspective view of a refrigerated smoking system comprising a liquid smoke receptacle, as described herein.

FIG. 5 illustrates an example process for refrigerated smoking products, as described herein.

### DETAILED DESCRIPTION

As described above, current techniques and methods for imparting smoke flavor in a product are limited. For example, a common method includes using a smoking device or “smoker”, in which products (often meat) are exposed to hot smoke, typically produced by a fire, over a prolonged period of time. Not only is this method time consuming, but it also requires specialized and often expensive products. Moreover, traditional smoking techniques occur at temperatures between 180 degrees Fahrenheit and 250 degrees Fahrenheit. For example, a typical process of smoking brisket may involve smoking the brisket at a relatively low heat (e.g., 225 degrees Fahrenheit) for a prolonged time (e.g., six hours). Thus, the product is exposed to smoke for a sufficient amount of time, and because the product is exposed to heat, it is cooked and ready for consumption while the smokey flavor is imparted. Another process of imparting smoke flavor referred to as “cold smoking” includes exposing a product to smoke at lower temperatures (e.g., ambient temperatures typically in the range of 65-85 degrees Fahrenheit). Cold smoking may be used on products that are to be smoked without “cooking” the product, such as cheese, some meats, and vegetables. In the case of many foods, the product must then be enjoyed within a handful of days before the product expires and is no longer safe for consumption.

As such, this disclosure is directed towards systems and methods for refrigerated smoking of products at temperatures below ambient temperature of the facility at which the products are being prepared. The refrigerated smoking systems and methods can be used to impart a smoke flavor into a variety of products, while under refrigerated conditions, thereby maintaining a raw version of the product capable of later preparation and consumption. In some examples, the smoke flavor maybe imparted under refrigerated conditions which are outside the food “danger zone,” a temperature range in which bacteria can grow more rapidly, as specified by the U.S. Department of Agriculture (USDA). In some examples of refrigerated smoking, the smoke flavor maybe imparted while maintaining a product below a threshold temperature (e.g., at or below 45 degrees Fahrenheit, at or below 42 degrees Fahrenheit, at or below 40 degrees Fahrenheit, etc.). Specifically, the system and methods described herein are designed to impart a smoke flavor onto products in a raw or uncooked state, while leaving the cooking process to the consumer.

It may be noted that although this application is described primarily as utilizing meats, any edible product may be used. In some examples, porous products, such as meats, cheeses, and fish, may be better capable of receiving and maintaining a smoke flavor as opposed to less porous foods, and may be more desirable. However, this disclosure anticipates the use of any product which a user may wish to impart a smoke flavor. By way of example and not limitation, products to which a smoke flavor can be imparted while under refrigerated conditions include, raw meats (e.g., individual cuts of meat, ground meat such as hamburger meat or sausage, etc.), dairy products (e.g., cheese, yogurt, cream, milk), alcoholic beverages (e.g., whiskey, wine, beer, etc.), dough (e.g., bread dough), plant matter (e.g., fruits, vegetables, tofu, etc.), deserts, etc.

In some examples, a refrigerated smoker, as described herein, may be configured to smoke a wide array of food items at low temperatures, thus preserving an initial state of the product. For example, the refrigerated smoker may comprise a smoke generator. The smoke generator may be any type of apparatus capable of producing smoke, such as a mechanical smoke generator, a wood-burning fire, a pellet-burning fire, or a gas-fueled fire, to name a few non-limiting examples. In some examples, the refrigerated smoker may additionally include a heat exchanger configured to decrease a temperature of the smoke. For example, the heat exchanger may be configured to receive the smoke from the smoke generator and cool the smoke to a lower temperature (e.g., 40 degrees Fahrenheit or lower). Additionally, or alternatively, the refrigerated smoker may include a refrigerated smoking chamber configured to receive at least a portion of the smoke from the heat exchanger.

In some examples, the refrigerated smoking chamber may be a hollow container capable of receiving one or more products to be smoked. For example, the refrigerated smoking chamber may include a door, which may allow a user to place the one or more products into the refrigerated smoking chamber. Additionally or alternatively, the refrigerated smoking chamber may have one or more racks for receiving food items disposed in an interior of the refrigerated smoking chamber. The one or more racks may include a grid or grate pattern, allowing the smoke to contact multiple sides of the one or more products, thus providing an even smoke distribution. Additionally or alternatively, the refrigerated smoking chamber may include one or more hooks, loops, clamps, or other hanging mechanisms to suspend the products in the container. In some examples, the refrigerated smoking chamber be may air-tight or at least partially air-tight, such that at least a portion of the smoke, once inside the refrigerated smoking chamber may be maintained inside the refrigerated smoking chamber. Additionally or alternatively, the refrigerated smoking chamber may be at least partially insulated in order to maintain an internal temperature of the refrigerated smoking chamber.

In some examples, an amount or concentration of smoke a product is exposed to and/or an amount of time a product is exposed to smoke may alter a flavor of the product. The concentration of the smoke in the chamber may be measured by an optical sensor configured to measure light transmittance values to determine optical density. Once the concentration has been determined by the optical sensor, the level may be adjusted within the chamber by either increasing the amount of smoke coming into the chamber or adjusting the rate of ventilation out of the chamber. Thus, the refrigerated smoking chamber may include one or more exhausts or vents which may allow at least a portion of the smoke to be released from and/or removed from the refrigerated smoking chamber. The refrigerated smoking chamber may additionally or alternatively contain one or more fans disposed in or coupled to the refrigerated smoking chamber, which may circulate air throughout the refrigerated smoking chamber, thus allowing an even amount of smoke to come into contact with the product(s). Additionally or alternatively, a fan may be included in or coupled to the smoke generator which can force air through the smoke generator to the smoking chamber via the heat exchanger. The fan may be adjustable to adjust a rate of air flow to increase or decrease the amount of smoke produced by the smoke generator. In some examples, the rate of smoke generation may be adjusted to better impart the smoke flavor on the various different products. For example, the rate of smoke generation needed to impart the smoke flavor into one or more dairy products may be less than the rate of smoke generation needed to impart the smoke flavor into various meat products. Additionally or alternatively, in some examples, a fan may be included in or coupled to the heat exchanger to help control airflow from the smoke generator to the smoking chamber. The fan associated with the heat exchanger may also be adjustable to control a rate of flow of air through the heat exchanger, which may be used to help control temperature of the smoke entering the smoking chamber and/or control an amount of condensation and liquid smoke generated at the heat exchanger. Further, in some examples, the refrigerated smoking chamber may include one or more timers, which may be associated with an amount of time a product is exposed to smoke. For example, after a completion of a period of time, the one or more vents and/or exhausts may be configured to release at least a portion of the smoke from the refrigerated smoking chamber. Additionally, unique smoke profiles may be imparted on the various products within the chamber by exposing the products to different types and flavors of smoke. For instance, the product may be exposed to a first type of smoke (e.g., smoke from hickory wood) at a first concentration for a first period of time and then exposed to a second type of smoke (e.g., smoke from apple wood) at a second concertation for a second period of time. Thus, by varying the type(s) of smoke, concentration(s) of the smoke, and the time(s) that products are exposed to the smoke, the products may be given specific and unique flavor profiles.

In some examples, the refrigerated smoker may include a receptacle capable of capturing liquid smoke that is generated as a byproduct of the refrigerated smoking process. Liquid smoke is smoke in a liquid form, rather than a gaseous form, and may be produced when smoke, generated at high temperatures (such as burning wood, for example), is rapidly cooled in temperature. For example, a liquid smoke receptacle may be coupled to the heat exchanger such that while smoke is being cooled by the heat exchanger, at least a portion of the smoke condenses and is converted to liquid smoke which is captured and received by the liquid smoke receptacle. In some examples, the liquid smoke may be separated and sold in liquid form as a separate product, may be provided in liquid form as an additional seasoning to a customer along with the refrigerated smoked product, may be dehydrated into a smoke powder, may be combined with a brine and then dehydrated to obtain a smoked salt, may be vaporized and introduced into the smoking chamber, may be applied to the product in liquid form during or after the refrigerated smoking process, or the like. The liquid smoke in any of these forms may also have a unique smoke profile that may be customized based on the type and concentration of smoke used during the refrigerated smoking process.

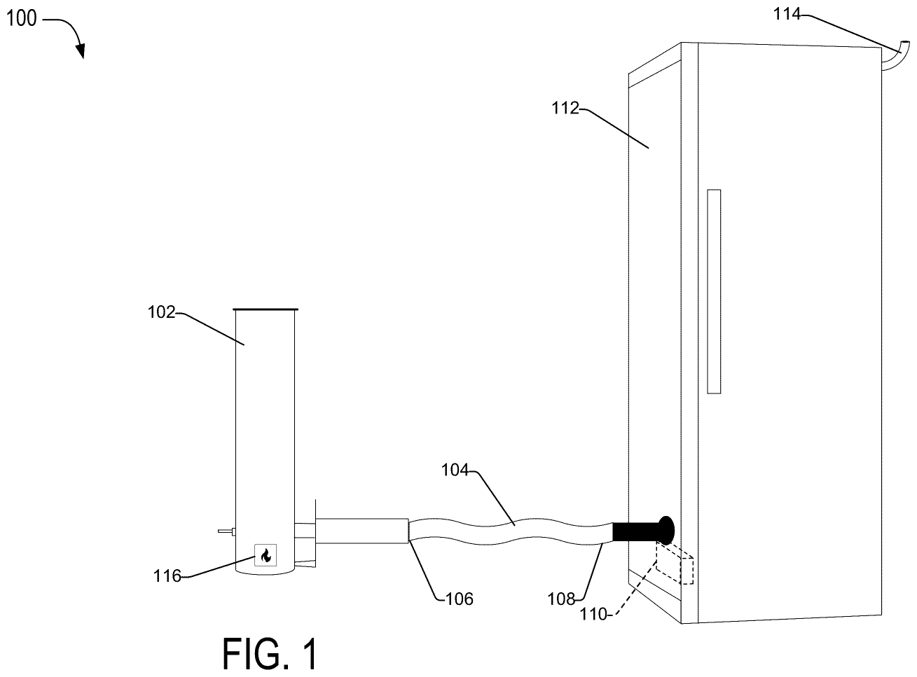

FIG. 1 illustrates a perspective view of an example refrigerated smoking system. In some examples, the refrigerated smoking system 100 may include a smoke generator 102. The smoke generator 102 may include any apparatus capable of producing smoke, such as, a wood-burning fire, a pellet-burning fire, a charcoal-burning fire, an electric powered smoke machine, or a gas-fueled fire, to name a few non-limiting examples. In some examples, the smoke generator 102 may be coupled to a heat exchanger 104. The heat exchanger may, in some examples, be configured to change a temperature of smoke. For example, a first end 106 of the heat exchanger 104 may be coupled to the smoke generator 102 such that the heat exchanger may receive, at the first end 106, the smoke generated by the smoke generator 102. In some examples, the heat exchanger 104 may be configured to cool the smoke from a first temperature (e.g., in the range of 150-700 degrees Fahrenheit) to a second temperature (e.g., in the range of 28-45 degrees Fahrenheit). In some examples, the second temperature may be lower than the first temperature, such as, for example, the first temperature may be at or above 150 degrees Fahrenheit and the second temperature may be at or below 45 degrees Fahrenheit. In some examples, the heat exchanger may include a shell and tube heat exchanger, a double pipe heat exchanger, a plate heat exchanger, or a fan-cooled heat exchanger (e.g., a fan blowing across a heat sink), or a combination of these, to name a few non-limiting examples. In some examples, the smoke generator 102 may contain one or more igniters for igniting the smoke generator, such as ignitor 116. The igniter 116 may include any type of ignitor, such as a furnace igniter, a forced heater igniter, a gas igniter, or a remote igniters, to name a few non-limiting examples. The igniter 116 may be the same or similar to igniters used in existing smoke generators, or may be a resistive heating element, a spark generator, or any other suitable ignition system.

In some examples, the heat exchanger 104 may include a second end 108 that may be coupled to a liquid smoke receptacle 110 configured to collect and/or remove liquid smoke. For example, liquid smoke is a liquid formed as water vapor contained in the gaseous smoke condenses in the heat exchanger, which may be produced as a by-product while the smoke is cooled from the first temperature to the second temperature. In some examples, it may be desirable for liquid smoke to be used as a cooking ingredient, such as a dehydrated smoke powder or a smoked salt, to name a few nonlimiting examples. Thus, the liquid smoke receptable 110 may be configured to collect liquid smoke that may be generated, such that the liquid smoke may be removed and used at a later time. The liquid smoke receptacle 110 may be disposed inline in with and downstream of the heat exchanger 104.

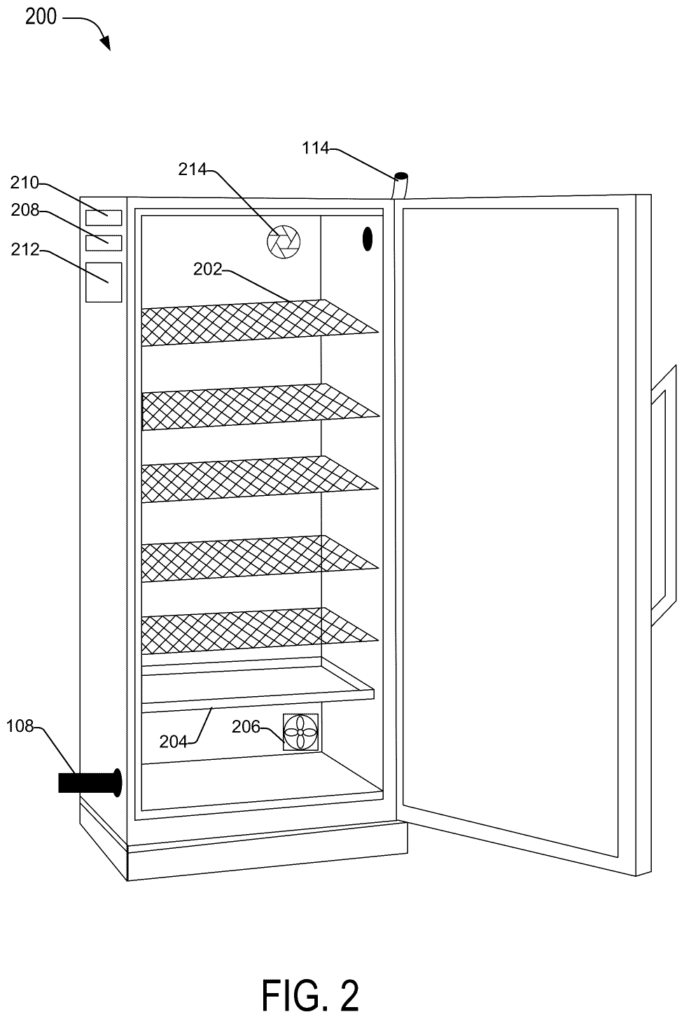

In some examples, the refrigerated smoking system 100 may include a refrigerated smoking chamber 112. For example, the refrigerated smoking chamber 112 may include a hollow container capable of receiving one or more products which may be exposed to the smoke. In some examples, the refrigerated smoking chamber 112 may include one or more exhaust mechanisms, such as vent 114, which may enable at least a portion of the smoke in the refrigerated smoking chamber 112 to exit the refrigerated smoking chamber 112 to an outside environment. In some examples, the liquid smoke receptacle may be disposed inside the refrigerated smoking chamber 112 (e.g., within a door of the refrigerated smoking chamber 112, on an inside of the door of the door of the refrigerated smoking chamber 112, or within a refrigerated compartment of the refrigerated smoking chamber 112). The refrigerated smoking chamber 112 is described in further detail in FIG. 2, below.

It may be noted that although the current illustration describes the smoke generator 102 being directly coupled to the heat exchanger 104 and the heat exchanger 104 being directly coupled to the refrigerated smoking chamber 112, the smoke generator 102, the heat exchanger 104, and/or the refrigerated smoking chamber 112 may be coupled to one another via any intermediary capable of transporting at least a portion of smoke, such as, for example, a pipe or a tube. In some examples, the intermediary may be insulated such that a temperature of the smoke may be maintained as it is traveling through the refrigerated smoking system 100.

FIG. 2 illustrates a perspective view of an example refrigerated smoking chamber system. The refrigerated smoking chamber 200 may be the same or similar as the refrigerated smoking chamber 112, as described above. In some examples, the refrigerated smoking chamber 200 may be capable of receiving one or more products, such as food items, to expose to smoke. For example, product(s) may be placed in the refrigerated smoking chamber such that smoke may come into contact with the product(s), adding a smoke flavor to the product(s). Thus, in some examples, the refrigerated smoking chamber 200 may include one or more racks 202 that product(s) may be placed onto. In some examples and as illustrated, the one or more racks 202 may be grated such that smoke circulating within the refrigerated smoking chamber 200 may come into contact with an underside of the product(s). However, any number and/or types of racks may be used. In some examples, the refrigerated smoking chamber 200 may additionally or alternatively contain a drip pan 204 or drip collection tray, which may be placed below the product(s) (e.g., disposed in a bottom of the refrigerated smoking chamber) and may be configured to receive any by-product produced from the product(s). Thus, any waste produced in the refrigerated smoking chamber 200 may be contained for ease of cleaning.

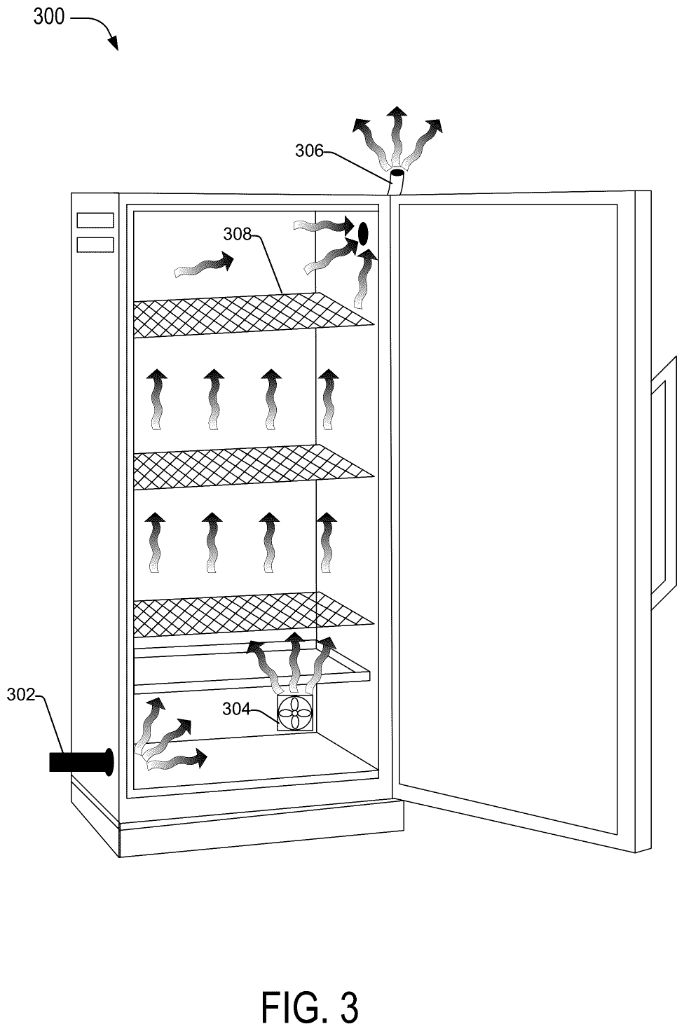

In some examples, it may be desirable to ensure that smoke within the refrigerated smoking chamber 200 is circulated, such that the smoke makes an even contact with the product(s) in the refrigerated smoking chamber 200. Thus, in some examples, the refrigerated smoking chamber 200 may contain one or more fans, such as fan 206. The dispersion of smoke within the refrigerated smoking chamber 200 is described below, in FIG. 3. Additionally or alternatively, fans may be included in and/or coupled to the smoke generator, the heat exchanger, or both, which can force an adjustable air flow through the smoke generator, from the smoke generator to the heat exchanger, through the heat exchanger, and/or from the heat exchanger to the smoking chamber 200.

In some examples, the refrigerated smoking chamber 200 may additionally or alternatively contain one or more timers, such as timer 208 and/or temperature gauges, such as temperature gauge 210. In some examples, the timer 208, temperature gauge 210, and/or the vent 114 may be in communication with one another (e.g., mechanically, via Bluetooth, etc.) such that product(s) may be exposed to smoke in the refrigerated smoking chamber 112 for a designated period of time and/or at a designated temperate. For example, the refrigerated smoking chamber 112 may have one or mechanisms that may enable a user of the refrigerated smoking system 100 to determine a temperature and/or a time that a product is exposed to smoke. For example, a user may determine a length of time that they wish for a product to be exposed to a certain temperature of smoke. The temperature gauge 210 may be in communication with a temperature gauge of the heat exchanger such that the heat exchanger may adjust a temperature the smoke generated by the smoke generator 102 is lowered to 40 degrees Fahrenheit or lower. In some examples, the vent 114 may be configured to release smoke in the refrigerated smoking chamber 200 to maintain a desired temperature. Moreover, in some examples, the vent 114 may be configured to release smoke within the refrigerated smoking chamber 200 such that after a period of time has elapsed, smoke may be removed from the product. In this way, users may be able to customize various flavors within various products.

In some examples, the refrigerated smoking chamber 200 may additionally or alternatively contain one or more network controllers, such as network controller 212. The network controller 212 may be configured to receive one or more inputs from one or more user devices (e.g., a tablet, a smart phone, a laptop, etc.) to control the refrigerated smoking chamber based on inputs. This may include, for example, controlling a length of time smoke is contained in the refrigerated smoking chamber 200 or an amount of smoke contained in the refrigerated smoking chamber 200, for example. In some examples, the network controller 212 may be configured for a wired connection (e.g., ethernet, powerline communication, etc.) and/or wireless connection (e.g., cellular, Wi-Fi, Bluetooth, Zigbee, etc.) of the refrigerated smoking system to a network and can include the applicable wired and/or wireless networking cards, radios, antennas, etc.

Additionally or alternatively, the refrigerated smoking chamber 200 may include a camera, such as camera 214. The camera 214 may be utilized to monitor one or more contents located inside the smoking chamber 200. In some examples, the camera 214 may transmit a video feed to a user device, such as via the network controller 212, such that a user may monitor a status of the contents of the smoking chamber 200.

FIG. 3 illustrates a perspective view for distributing smoke within a refrigerated smoking chamber. The refrigerated smoking chamber 300 may be the same or similar as the refrigerated smoking chambers 112 and 200, described above. In some examples, the refrigerated smoking chamber 300 may receive smoke from a heat exchanger, such as heat exchanger 302. In some examples, the refrigerated smoking chamber may contain one or more fans 304, such that the smoke may be circulated throughout the refrigerated smoking chamber 112. In some examples, the refrigerated smoking chamber 112 may additionally or alternatively include a vent, such as vent 306, which may enable at least a portion of the smoke to exit the refrigerated smoking chamber 300 to an outside environment. As depicted in FIG. 3, smoke (illustrated by arrows) may rise through various racks 308 such that the smoke may contact an underside of a product placed on the racks 308. Moreover, as illustrated in the current figure, the smoke has risen to a top of the refrigerated smoking chamber 300 and has exited via the vent 306.

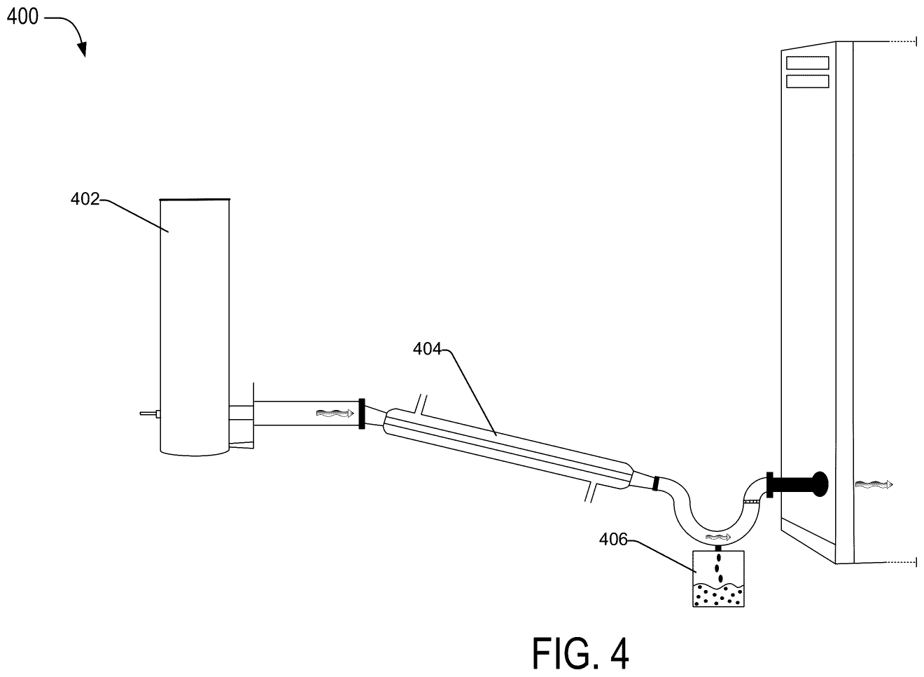

FIG. 4 illustrates a perspective view of a liquid smoke receptacle of a refrigerated smoking system 400. In some examples, a refrigerated smoking system 400 may contain a smoke generator, such as smoke generator 402, which may be configured to generate smoke. For example, the smoke generator 402 may comprise a wood-burning fire, a pellet-burning fire, a charcoal-burning fire, an electric smoke generating machine, or a gas smoke generating machine, to name a few examples. The smoke generator 402 may be coupled to a coupled to a heat exchanger, such as heat exchanger 404, which may be configured to receive the smoke generated by the smoke generator 402. In some examples, a liquid smoke receptacle 406 may be coupled to the heat exchanger 404. For example, as described above, liquid smoke, a liquid form of the gaseous smoke, may be produced as a by-product of rapidly cooling smoke. In some examples, the liquid smoke receptacle 406 may be coupled to the heat exchanger 404 such that the liquid smoke receptacle 406 may receive and contain at least a portion of liquid smoke generated during a cooling of the smoke.

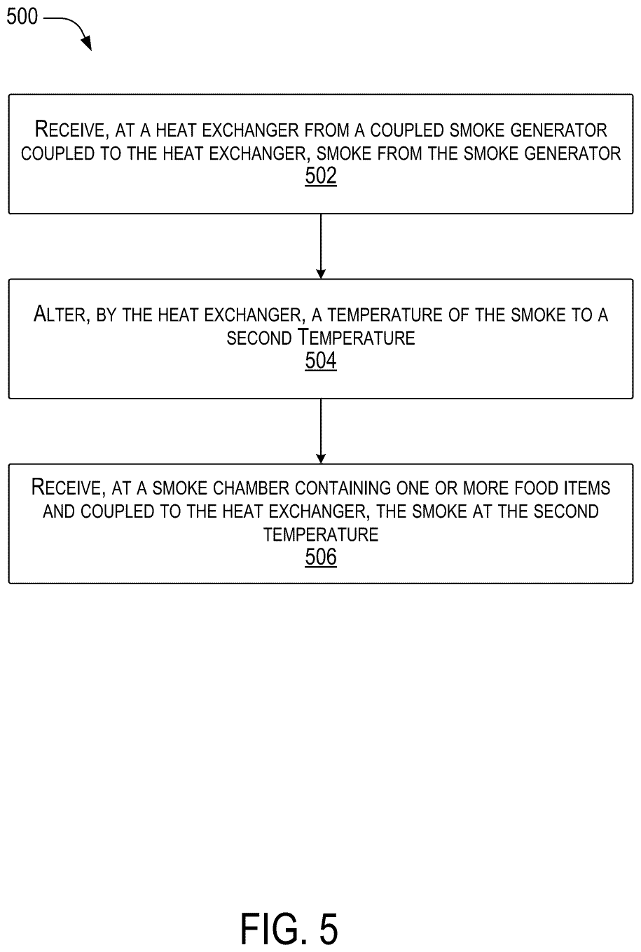

FIG. 5 illustrates an example process for refrigerated smoking products. For example, at operation 502, the process may include at least receiving, at a heat exchanger and from a smoke generator coupled to the heat exchanger, smoke from the smoke generator. For example, a smoke generator may be any mechanism for generating smoke, such as a wood-burning fire, a pellet-burning fire, a charcoal-burning fire, an electric powered smoke machine, or a gas-fueled fire, to name a few non-limiting examples. In some examples, the generated smoke may be at a first temperature, such as for example 150-700 degrees Fahrenheit.

At operation 504, the process 500 may include at least altering by the heat exchanger, a temperature of the smoke to a second temperature. For example, the heat exchanger may be configured to receive the smoke from the smoke generator and cool the smoke to a second, cooler temperature (e.g., 45 degrees Fahrenheit, 40 degrees Fahrenheit, or lower). In some examples, the first temperature at which the smoke is received may be over a desired threshold temperature (e.g., above 150 degrees Fahrenheit, above 85 degrees Fahrenheit, etc.). The heat exchanger may cool the smoke to a second temperature below the threshold temperature. In some examples, the second temperature may be below ambient temperature, below 40 degrees Fahrenheit, etc. In this way, the heat exchanger provides the smoke to the smoking chamber at a temperature that does not raise a temperature inside the smoking chamber. The heat exchanger may be any mechanism for exchanging heat, such as a shell and tube heat exchanger, a double pipe heat exchanger, a plate heat exchanger, or a fan cooled heat exchanger, to name a few non-limiting examples.

At operation 506, the process 500 may include at least receiving, at a refrigerated smoking chamber containing one or more products and coupled to the heat exchanger, the smoke at the second temperature such that the smoke contacts at least a portion of the one or more food item(s). For example, the refrigerated smoking chamber may include a door, which may allow a user to place the food item(s) into the refrigerated smoking chamber. The refrigerated smoking chamber may additionally, in some examples, have one or more racks to place the food item(s) onto. The one or more racks may be configured in a grid or grate pattern, allowing the smoke to contact multiple sides of the food product(s), ensuring an even smoke distribution. In some examples, the refrigerated smoking chamber maybe air-tight or at least partially air-tight, such that at least a portion of the smoke, once inside the refrigerated smoking chamber, may be maintained inside the refrigerated smoking chamber. In other examples, the refrigerated smoking chamber may be at least partially insulated in order to maintain an internal temperature of the refrigerated smoking chamber.

In some examples, smoke-infused products generated by the refrigerated smoking methods described herein may be saved for later distribution and use. For example, once a product has been exposed to the smoke in the refrigerated smoking chamber for a desired length of time, the product may be removed. Due in part to the low temperature of the refrigerated smoking chamber, the product may be maintained in a “raw” state, or a state which may allow the product to be consumed at a later time. As an illustrative example, a product may include a raw steak. After a desired smoke exposure in the refrigerated smoking chamber, the steak may include a smoke flavor while still being un-cooked. The raw steak may be cooked at a later time (e.g., after being frozen and thawed), using desired cooking methods, while maintaining the steak's smokey flavor. Thus, in some examples, products may be packaged and used at a later time. For example, the product may be vacuum sealed to maintain the flavor imparted onto the product. In some examples, additional smoke may be injected into the vacuum sealed container to allow the product to obtain an even smokier flavor. Thus, allowing the products to be imparted with additional smokey flavor after the refrigerated smoking method dependent on the flavor concentration desired by the retailer or consumer.

What is claimed is:

1. A refrigerated smoker comprising:
a smoke generator;
a heat exchanger comprising a first end and a second end, wherein the first end of the heat exchanger is coupled to the smoke generator and configured to receive smoke from the smoke generator and wherein the heat exchanger is configured to configured to decrease a temperature of smoke to a decreased temperature; and
a refrigerated smoking chamber coupled to the second end of the heat exchanger and configured to receive the smoke at the decreased temperature.

2. The refrigerated smoker of claim 1, further comprising a container coupled to the heat exchanger, wherein the container is configured to receive liquid smoke.

3. The refrigerated smoker of claim 1, further comprising one or more fans disposed in or coupled to the refrigerated smoking chamber and configured to circulate the smoke throughout the refrigerated smoking chamber.

4. The refrigerated smoker of claim 1, wherein the smoke generator comprises at least one of:
a wood-burning fire;
a pellet-burning fire;
a charcoal-burning fire;
an electric smoke generating machine; or
a gas smoke generating machine.

5. The refrigerated smoker of claim 1, wherein the heat exchanger comprises at least one of:
a shell and tube heat exchanger;
a double pipe heat exchanger;
a plate heat exchanger; or
a fan-cooled heat exchanger.

6. The refrigerated smoker of claim 1, wherein the heat exchanger is configured to decrease the temperature of the smoke to 40 degrees Fahrenheit or below.

7. The refrigerated smoker of claim 1, further comprising a timer communicatively coupled to the smoke generator to control an amount of time that smoke is imparted to the refrigerated smoking chamber.

8. The refrigerated smoker of claim 1, further comprising a sensor configured to measure a concentration of the smoke in the refrigerated smoking chamber.

9. The refrigerated smoker of claim 1, further comprising a drip collection tray disposed in a bottom of the refrigerated smoking chamber.

10. The refrigerated smoker of claim 1, further comprising one or more racks capable of receiving a food item disposed in an interior of the refrigerated smoking chamber.

11. A method comprising:
receiving, at a heat exchanger and from a smoke generator coupled to the heat exchanger, smoke from the smoke generator, wherein the smoke from the smoke generator is at a first temperature;
altering, by the heat exchanger, temperature of the smoke to a second temperature; and
receiving, at a refrigerated smoking chamber containing one or more food items and coupled to the heat exchanger, the smoke at the second temperature such that the smoke contacts at least a portion of the one or more food items.

12. The method of claim 11, wherein the second temperature is lower than the first temperature.

13. The method of claim 11, further comprising receiving liquid smoke at a container coupled to the heat exchanger, wherein the container is configured to receive the liquid smoke.

14. The method of claim 11, the refrigerated smoking chamber further comprising a one or more fans configured to circulate the smoke throughout the refrigerated smoking chamber.

15. The method of claim 11, wherein the smoke generator comprises at least one of:
a wood-burning fire;
a pellet-burning fire;
a charcoal-burning fire;
an electric smoke generating machine; or
a gas smoke generating machine.

16. The method of claim 11, wherein the heat exchanger comprises at least one of:
a shell and tube heat exchanger;
a double pipe heat exchanger;
a plate heat exchanger; or
a fan-cooled heat exchanger.

17. The method of claim 11, the refrigerated smoking chamber further containing a timer.

18. The method of claim 11, the refrigerated smoking chamber further containing a drip collection tray.

19. The method of claim 11, the refrigerated smoking chamber further comprises one or more racks capable of receiving the one or more food items.

20. The method of claim 11, wherein the method imparts a smoke flavor to a product while the product is in a raw or uncooked state, and wherein the method preserves the product in the raw or uncooked state.
